(19) United States
(12) Patent Application Publication
(10) Pub. No.: US 2015/0128474 A1
(43) Pub. Date: May 14, 2015

(54) SIMULATED LIVE BAIT

(71) Applicant: CREATIVE IMPACT INC., Tortola (VG)

(72) Inventor: Lance Scott JAMES, Forked River, NJ (US)

(73) Assignee: CREATIVE IMPACT INC., Tortola (VG)

(21) Appl. No.: 14/077,143

(22) Filed: Nov. 11, 2013

(51) Int. Cl. A01K 85/01; A01K 85/16

(52) U.S. Cl. CPC A01K 85/01; A01K 85/16
USPC 43/17.6; 43/42.32; 43/42.31; 43/42.06

(57) ABSTRACT

An active fishing lure comprising a body able to simulate some appearance and at least some movement of a bait species. The body is adapted for line attachment (directly or indirectly) and attachment to at least one hook. A battery is carried by the body and is connectable to a drive to cause at least some movement of the body.

### FIELD OF THE INVENTION

The present invention relates generally to fishing lures and more particularly but not exclusively it relates to fishing lures with increased mechanical activation.

### BACKGROUND

Fishing lures may be used as an alternative to, or in addition to, baits designed to attract a fish's attention. Lures are attached near the end of a fishing line and may have one or more fishing hooks attached to the lures, so that fishing hook catches a fish biting a fishing lure. Some lures are placed to attract fish so a spear can be impaled into the fish or so the fish can be captured by hand. Most lures are attached to the end of a fishing line and have various styles of hooks attached to the body and are designed to illicit a strike resulting in a hookset.

Fish respond to visual, auditory, olfactory, gustatory and tactile stimuli to locate prey or navigate in their habitats. Anglers using conventional fishing lures exploit some of these stimuli to attract their catch.

Other accessories that may be used with a fishing line include a swivel to prevent the fishing line from being twisted, a snap clip for quick release of a part of the fishing line, and a sinker to facilitate casting and sinking of the fishing lure.

The capacity of landing a catch with a lure may depend on many factors, such as the anglers' skills and knowledge of the targeted catch, all within the limitations of conventional fishing lures.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

Accordingly, in a first aspect the present invention may be said to be an active fishing lure comprising or including:

a body able to simulate some appearance and at least some movement of a bait species, the body being adapted for line attachment (directly or indirectly) and mounting or being attached to or being adapted to attach to at least one hook,

an energy storage device carried by or forming part of the body or its content,

a drive connected to the energy storage device able to cause said at least some movement of the body, and

an initiator able to initiate the drive and thus the active movement of the body whilst drawing energy to the drive from the energy storage device.

Preferably the initiator is selected to initiate the drive in manner being one of:
Manual initiation
water immersion initiation.

Preferably the drive is water immersion maintained

Preferably the drive is timer deactivated.

Preferably the drive is timer activated.

Preferably the lure can be configured and adapted to have negative buoyancy, neutral buoyancy or a positive buoyancy device.

Preferably the body simulates the head and tail of a bait species fish and the active movement is a swishing of such tail.

Preferably the lure can be adjustable in respect of its centre of gravity relative to its centre of buoyancy.

Preferably the hook is presented from said body.

Preferably the hook is rigidly secured or integrally formed with the body.

Preferably the hook is adapted to attach to said line.

Preferably the body is adapted to attach to said line.

Preferably said body is able to transmit into water a fish attractant comprising at least one of:
a. light
b. sound
c. vibration
d. scent such as pheromones.

Preferably said drive is remotely controllable.

Preferably said drive is controlled by input from a remote source.

Preferably the remote source is coupled to a fish finder capable of sensing fish in proximity of the lure and cause the drive to make the lure become more sensed by said fish when in proximity of the lure.

In a second aspect the present invention may be said to be a fishing lure of a kind attached to or adapted to attach to a fishing line or trace or snood thereof (whether through a swivel or like device or not) and of a kind mounting, attached to or adapted to attach to at least one hook (whether through a swivel or like device or not), the lure being characterised in that it has a movement capability able to be initiated by one selected from manually and by water immersion and reliant on an energy storage device of the lure.

Preferably the movement capability is a swishing articulation of the body simulating the movement that propels a bait species through a body of water.

In a further aspect the present invention may be said to be an active fishing lure comprising a body carrying an energy source and requiring water immersion to cause a draw of power from its energy storage device to a movement drive that causes some activity of the lure in the water.

Preferably the activity is a motion of the body.

Preferably the body is articulated and the motion is an oscillatory articulation of the body.

Preferably the activity is to simulate the swimming movement of a fish bait species.

Preferably the drive can be initiated other than by water immersion.

Preferably the drive may be terminated by a timer.

In still a further aspect the present invention may be said to be a fishing lure able to self articulate provided it being maintained in the water being fished, such articulation being independent of any water movement over the lure.

Preferably said articulation is caused by an electrically powered drive of said lure.

Preferably said articulation simulates the tail swishing of a bait fish.

In another aspect the present invention may be said to broadly consist in a non-live self swishing (or writhing, wriggling, contorting, squirming, articulating, twisting or thrashing) fishing lure.

In still a further aspect the present invention may be said to be a fishing lure able to be activated and/or reactivated and/or be maintained active under any one or more of the following modes to articulate, wriggle, swish or the like to simulate the movement of an appropriate bait creature (real or otherwise), said movement to be of part or some of the lure relative to some other part or portion responsive to a drive rendered active from an energy storage device; said modes being at least some of
manual activation
liquid immersion activation or reactivation
timer ceased deactivation followed by liquid immersion reactivation.

Preferably at least one of the liquid immersion modes is involved.

Preferably all three modes are involved.

Optionally the lure has
(i) a head or head and body part or portion, and
(ii) a tail as a part or portion dependent from (i).

Preferably the creature is a real type creature (e.g. a bait fish, tadpole, worm, squid, amphibian, or the like).

Preferably the active movement is a tail swish movement.

Preferably the energy storage device is a battery or capacitor.

Preferably the device doesn't operate after removal from water.

In a further aspect the present invention may be said to be a kit comprising a lure as herein before described and a hook able to be directly or indirectly associated with the body of the lure.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “swishing” as used in this specification can mean many types of movement that may be desired for target fish to be attracted to, such as contorting, walking, writhing, wriggling, swishing, squirming, articulating, twisting or thrashing.

The term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The invention will now be described by way of example only and with reference to the following drawings:

FIG. 1 is a schematic diagram of one example of the external structure of an embodiment of the lure in the form of a simulated fish.

FIG. 2 is a schematic diagram of the internal structure of FIG. 1 without one side of its shell body.

FIG. 3 is a schematic diagram of the transverse section of the tail in FIG. 1.

FIG. 4 is a schematic diagram of a charging seat cover for use with the lure.

FIG. 5 is a schematic diagram of the coil bracket of the tail of the lure.

FIG. 6 is a schematic diagram of a light emitting aspect of the lure.

FIG. 7 is an illustration of an alternative coil and magnet configuration that may be used to oscillate the tail of the lure.

FIG. 8 is an illustration of yet another alternative coil and magnet configuration that may be used to oscillate the tail of the lure.

FIG. 9: shows a side view of a lure with two hooks, one hook attached to a line.

FIG. 10: shows a different embodiment of FIG. 9.

FIG. 11: shows a different embodiment of FIG. 9.

FIG. 12: shows one embodiment of the lure and line setup in use.

FIG. 13: shows the lure pulling down a line in use.

### DETAILED DESCRIPTION OF EXAMPLE EMBODIMENT(S)

The simulated live bait (or lure) 1000 is preferably of a fish type configuration. It is designed to function in a biomimetic manner. It may comprise a body shaped like a fish with an electrically powered fish tail shaped propeller, which is of a kind as described in WO2013/007181A1. The following description will be with reference to this fish shaped configuration, however it is envisioned that the lure 1000 may be of any suitable shape designed to attract the particular species of fish the fisherman wants to catch. Such shapes may be; other fish or sea creatures or any conventional or alternative lure 1000 shape that would be desirable to be capable of moving under its own power.

The lure's propeller drives the lure through the water in an action mimicking a live bait fish. The lure 1000 also has at least one hook 100 that is associated such as by being attached, or able to be attached to the body 1 of the lure—the lure 1000, via the body 1 and/or the hook 100 in turn being attached to the fishing line of the fisherman. When a targeted fish tries to eat or bite the lure, the hook 100 ensnares/hooks the target, thus attaching the target to the lure 1000 and thus line 103, allowing the fisherman to retrieve the target from the body of water.

The lure 1000 attracts the target by one or several means, the primary mean being the lure 1000 simulates the tactile or movement stimuli relating to a bait fish. It may also attract targets via other stimuli such as visual, olfactory, gustatory, auditory, vibrations, and or magnetic or electric variations.

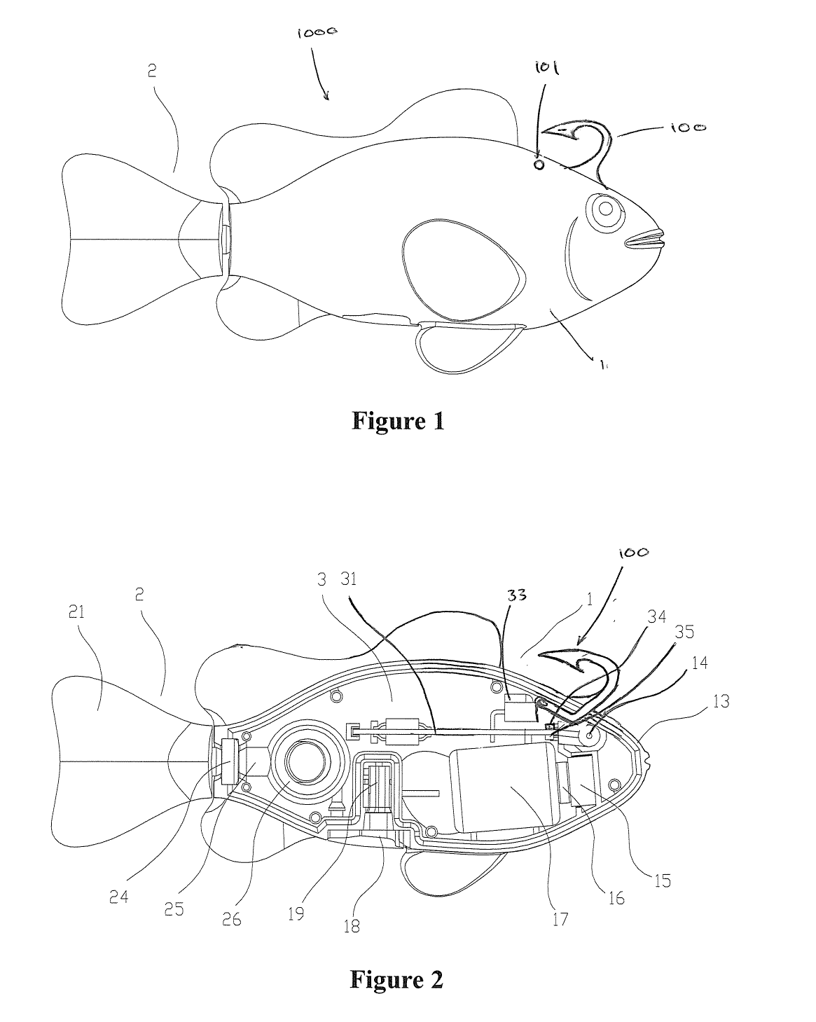

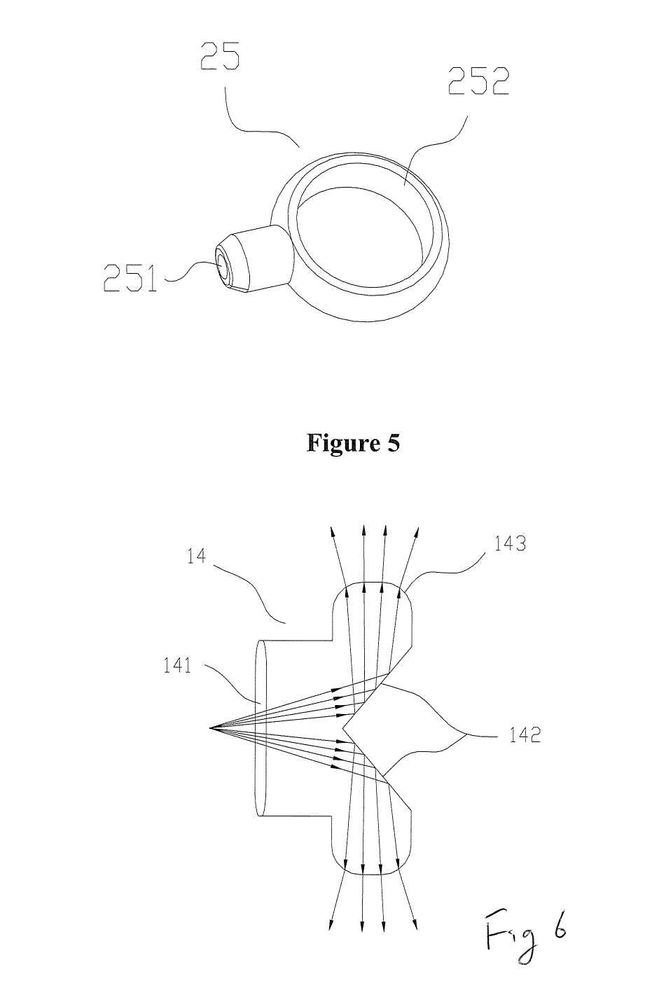

Referring to FIGS. 1 to 7, the lure 1000 of the present invention is may be a biomimetic fish. The fish comprises of a body 1 and a propeller, preferably in the form of a fish tail assembly 2. The fish tail assembly 2 is engaged or integrally formed with the body 1. The fish is preferably of a buoyant configuration, however neutral of negative configurations may be used.

The fish tail assembly 2 comprises a fish tail 21 that can make a swishing oscillatory like motion relative to the body and thereby propel the fish through the water. The body 1 is preferably made from a rigid plastic and the tail 21 from a more flexible plastic. However, alternative appropriate materials may be used.

Lures may be attached near the end of a fishing line 103 and may have one or more fishing hooks attached to the lures, so that fishing hooks catch a fish biting a fishing lure. Some lures are placed to attract fish so a spear can be impaled into the fish or so the fish can be captured by hand. Most lures may be attached to the end of a fishing line and have various styles of hooks attached to the body and are designed to illicit a strike resulting in a hookset.

Some target fish strike their prey/lures from the rear, whilst others may strike from the front of the lure. Other target fish may nibble or attempt to bite a fish. Therefore there can be many different types of hook arrangements that integrate with the lure. I.e. should the target fish strike from the front of the lure, the hook 100 needs to hook back towards the lure, to allow the target to become hooked. And vice versa with rear striking target fish.

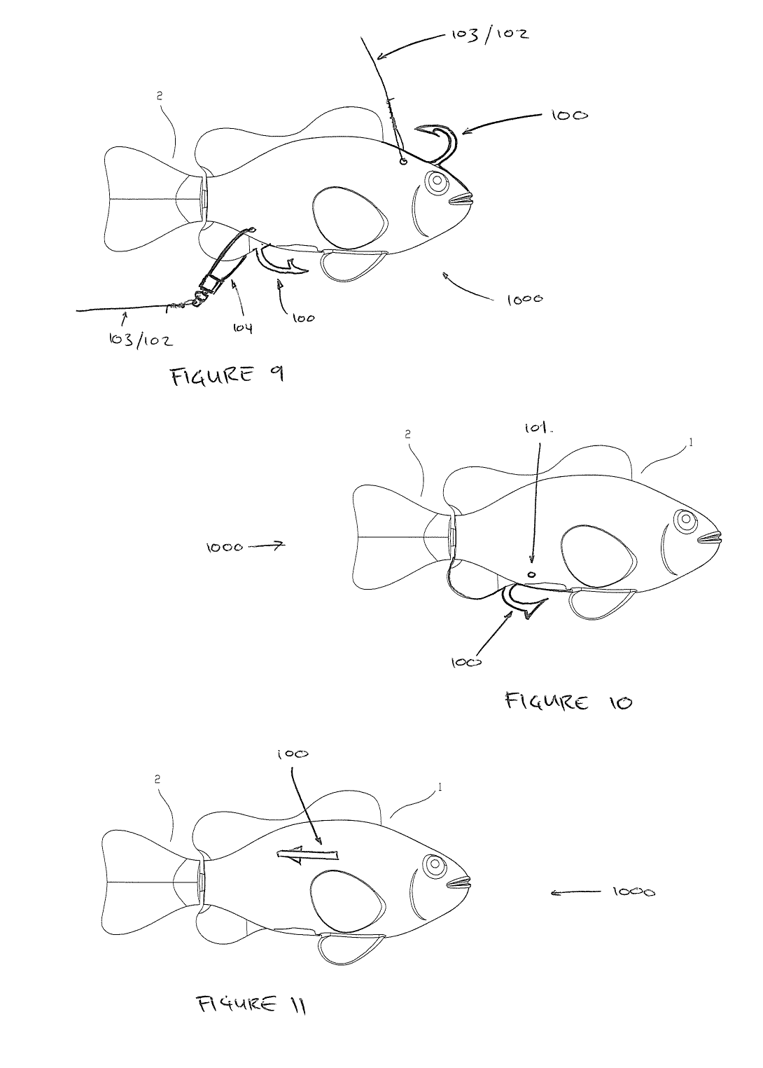

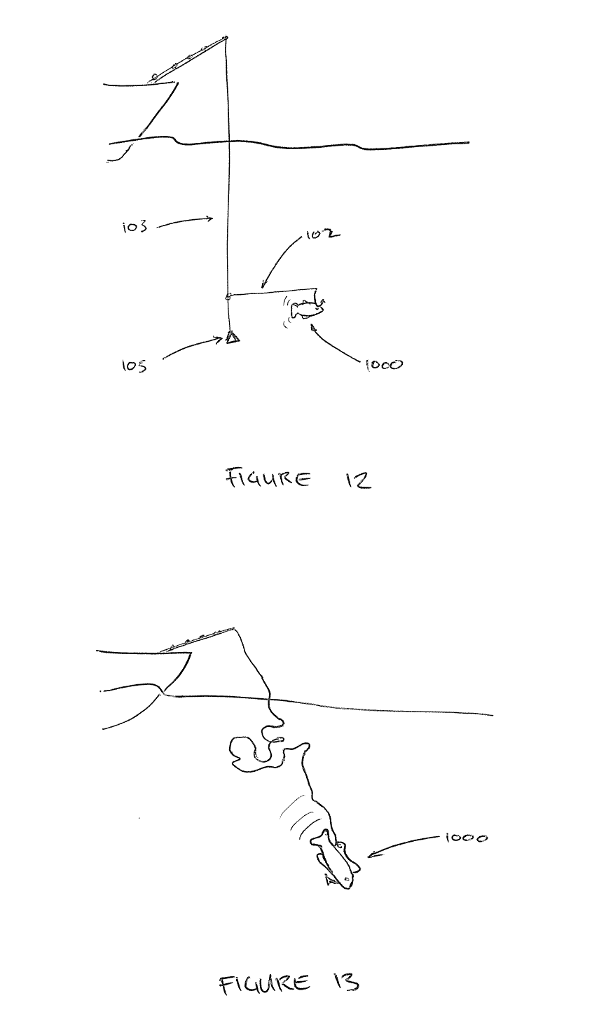

Preferably the body 1 is adapted for line attachment (directly or indirectly) and mounting or being attached to or being adapted to attach to at least one hook or the lure 1000. The hook attachment 101 is similar to conventional lures of the same purpose. FIGS. 9 to 11 show a line attachment hole 101 to thread a fishing line through, or attach a snap clip 104 to. The 102 hole threads through the part of the hook body, this provides good strength when hauling in a target fish and takes away any stress or strain on the lure. I.e. all force between the fisherman and the target fish goes through the metal hook 100.

Preferably the hook 100 is integrally formed with the body of the lure. Preferably the hook 100 is co-molded within the body. Alternatively the lure 1000 is attached to a line, which in turn attaches to the hook. See FIGS. 9-11 for non-exhaustive examples of different hooking positions, and line attachments methods.

In the preferred embodiment the body 1 comprises a left shell body 11 and a right shell body 13. The fish tail assembly 2 is pivotally or floatingly disposed from the body assembly. The fish tail assembly 2 may gain support of both the left shell body 11 and right shell body 13, and a sealing ring 24 and a support bracket 23. A tail shaft 22 of the fish tail assembly 2 has an inner end and an outer end. The inner end penetrates through a central hole of the sealing ring 24. The outer end of the tail shaft 22 carries the fish tail 21.

A coil and magnet arrangement is preferably disposed in the body assembly 1. The coil can be energized to cause the tail to oscillate. In alternative embodiments, different mechanisms may be used to more satisfactorily mimic the movement of a particular bait fish which is attractive to said target fish. I.e. instead of a swishing tail, the drive may come from a wiggling of the body like an eel or tadpole, or the kicking of legs like a frog or alligator, or the movement of legs like a crab. Further movement of the lure, not essentially for movement may be used to attract target fish, such as writhing, wriggling, thrashing, articulating etc.

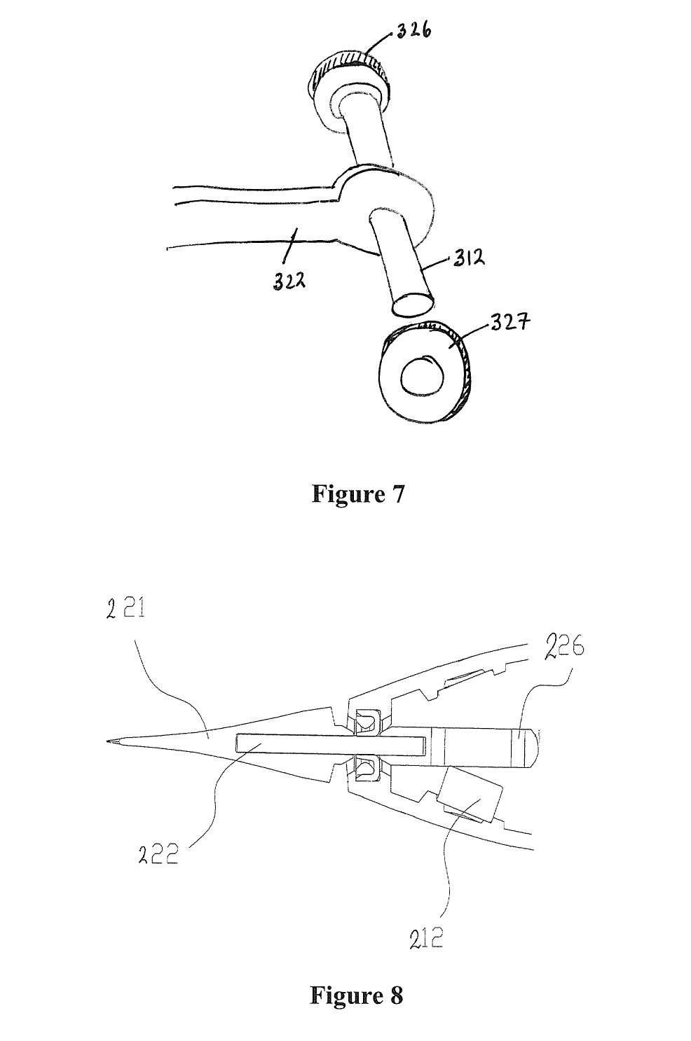

In one form the coil and magnet arrangement may be presented in a manner where two magnets 12 and one coil 26 are present in the body assembly 1. However, in other forms there may be one magnet and one coil, see FIG. 8, or one magnet and two coils, see FIG. 7.

In use, when the coil or coils are energized magnetic poles are induced in the coil or coils and these magnetic poles interact with the magnetic poles of the magnet or magnets.

In the preferred form of the lure, the inner end of the tail shaft 22 carries the coil 26. The inner end of the tail shaft extends into a hole 251 of a coil bracket 25, and a coil 26 is fixed in the central hole 252 of the coil bracket 25.

In the preferred configuration the body 1 carries two magnets 12. These two magnets 12 are respectively secured each on an inner side of each right and left side shells 11, 13. Therefore, a magnet 12 sits of each side of the coil when it is in a central location. Preferably the opposite surfaces of the two magnets are of the same polarity, and the coil is disposed such that the coils central axis is perpendicular to the central horizontal axis through the lure fish. In use, when the coil is energized the magnetic poles formed in the coil, cause the coil to be are attracted to one of the magnets and repelled by the other of the magnets.

In other embodiments the magnet and coil configuration may be different, but have the same effect. For example, in FIG. 8, when an alternating current to applied to the coil 226, an alternating magnetic pole is induced in the coil, that interacts with the single magnets 212 pole, causing the shaft 222 and tail 221 to move. Similarly, in FIG. 7, when an alternating current is applied to each of the coils 326, 327 the magnetic poles induced in the coils interact with the poles of the magnet and cause the magnet and thus the shaft 322 to move.

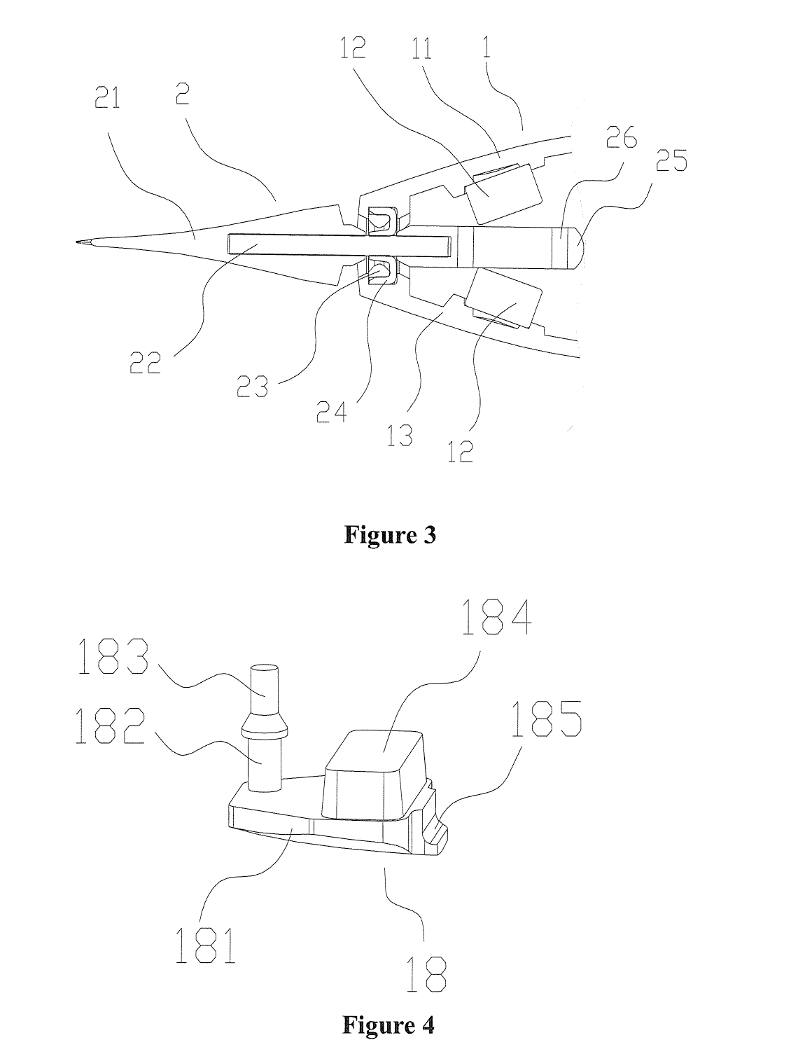

In the preferred configuration of FIG. 3, a drive control circuit 3 is disposed in the body 1. When the drive control circuit 3 supplies electric current to the coil 26 the magnetic field induced in the coil 26 interacts with the magnetic field produced by both magnets 12. This creates an attraction force at one side of the coil 26 and a pushing force at the other side of the coil 26. This causes the coil 26 and bracket 25 to pivot or lean towards one or other magnet 12, causing the tail shaft 22 to swing in the opposite direction to the movement of the coil and bracket. When the current direction is changed, the force directions are changed accordingly and the tail shaft 22 is moved in the opposite direction. Thus with consecutive changes in the current in the coil 26 and changing of the magnetic poles in the coil, the tail shaft is causes to swing in an oscillatory manner. The swinging of the tail causes the tail 21 to propel the body assembly 1 forward.

Additionally, in the preferred form of the lure, an activation circuit is provided for the lure. The activation circuit is associated with the drive control circuit and is provided to activate the energization of the coil(s). The activation circuit may be selected from one of (a) a vibration switch and (b) moisture sensor or (c) terminals of a circuit or switching circuit that complete an electrical circuit via water in which said lure 1000 may be placed or (d) capacitance switch or (e) other. In other embodiments, the activation circuit may comprise an external switch such as a rocker switch or slide switch, to be activated by a fisherman prior to the lure 1000 entering the water. This is because onboard fishing boats, a moist environment is often prevalent, and a moisture sensor may not be appropriate.

A deflecting force can be produced when the fish goes forward if the fish tail is at a certain angle to the fish body. This will cause the fish to turn. Different durations of swing of the fish tail on opposite sides of the fish centerline will cause a non-symmetric deflecting force and the fish can turn accordingly. Thus the fish's moving direction can be changed by altering the forward-direction and backward-direction current pulses in the coil 26, which is supplied by the drive control circuit 3. The altering of the current pulses may be by way of duration, amplitude or by applying an offset sine wave current pulse to the coil or coils.

Different turns and swimming patterns may be programmed to target different target fish. For some targets, the swimming pattern or cycle may be very twitchy and fast to attract the target. For targets that prefer more sedate bait, the lure 1000 may swim slowly.

In the preferred form the drive control circuit 3 may comprises a PCB 31 and LED indicator lights 34 and 35. The indicator lights 34, 35 are capable of showing a status of activation of the fish or charging of the fish respectively. The drive control circuit is powered by a battery 17.

In some forms of the invention, the drive control circuit 3 may include an infrared receiving tube 33. The infrared receiving tube 33 is capable of receiving a transmitted remote control signal from a transmitter outside the fish. In response to the transmitted signal, the control circuit will execute a corresponding operation according to the received signal.

Referring to FIG. 6, the operation of the indicator lights 34, 35 will be described. When the drive circuit is in operation, the LED indicator light 34 is lit up. Alternatively, when the fish is charging, a different LED indicator light 35 is lit up. Light from each of these hits the incident surface 141 and then the reflector 14. Light can be reflected by two reflecting surfaces 142 to be emitted to both sides of the fish out through the fish eyes 143, 144.

The or other lights preferably are also used in use to attract target fish. The light preferably is blue or green—the space colors of fish and members of their food chain. However, while blue or green light is desirable it is not essential. Even if the eyes of fish or members of its food chain have color receptors most sensitive to the blue or green, these same receptors have a broad but decreased sensitivity to other colors. So, if a fishing light source is intense enough, other light colors will also attract. The perfect fishing light would have the following properties: 1) high intensity, 2) emit its light in a color similar to the fishes space (blue or green).

Lights on the lure, may be optimised to target particular target fish by being on a programmed cycles to flash or similar, to attract the target.

Preferably, the lure 1000 comprises a light sensor that can activate the lights to only operate when light conditions are low and the lure is in an activated condition—thus using the lights only when they will be visible, therefore saving battery power or energy.

The fish body may be internally provided with an additional coil 15, and at least one additional magnet 16 (however, more than one magnet may be used), that is attached to the battery 17 that powers the drive control circuit 3. A magnetic field generated by the coil when the coil 15 is supplied with an electric current (from the drive control circuit), interacts with the magnet 16 to create an attraction force or a pushing force to drive the battery 17 to move. When the battery moves forward the center of gravity of the fish shifts forward simultaneously, such that a downward component force is produced to drive the fish downwards while the fish tail 2 is operating. When the magnet 16 drives the battery 17 to move backward, the center of gravity of the fish shifts backward simultaneously, effectively lifting the fish head, such that there will be an upward component force to drive the fish upwards while the fish tail 2 is operating. This or other means may also be provided to create further vibration for the lure. Target fish may be attracted to such vibration as it may signal to the target species that a creature in distress is near thereby offering easy to capture food.

An alternative method of changing the center of gravity of the fish is to fix a magnet 16 and allow a coil to be movable, such that the coil drives the battery or any other counterweight member to move. The movable counterweight member cannot be made of magnetic material such as iron or the like; otherwise an attraction force will be produced between the movable member and the magnet that would interfere with the correct action of the coil.

Alternatively the fish's center of gravity can be adjusted in a right-left direction using either of the above methods but when the above mechanisms are arranged transversely. Again, alternatively, the fish's centre of gravity can be adjusted in a forward-backward direction when either of the above mechanisms are arranged vertically.

As with turning using the tail, controlling the lures movement with change in centre of gravity can be programmed to control or move the lure 1000 in ways to target particular target fish.

The fisherman may not use a sinker 105 to sink the lure 1000, like in conventional setups, instead the fisherman may utilize the downward thrust available from the lure 1000 to pull their line downwards as shown in FIG. 13.

Further embodiments may include a sinker; however the lure 1000 is on a lateral snood 102. So the fisherman may drop his (main) line 103 down to certain level, and the lure 1000 can swim or drive laterally out from the main line as shown in FIG. 12. This setup is preferably for targeting fish at certain depths, over a larger area, or under shelves. The lure may swim generally in a circle around the main line.

The battery 17 may be replaceable or capable of being charged in-situ through a port in the fish shell. A plug can be inserted into a charge socket 19 by opening a waterproof cover 18 on the fish shell.

However, other plug and socket arrangements for charging as are known in the art may be used with the lure 1000 fish of the present invention.

The charging cover 18 is shown in FIG. 4. The charging cover comprises a post 183, plug 184 and base 181, that when the charging cover 18 is closed over the port 19, is inserted into port 19. The cover 18 is made of a plastics material and each of the post 183 and plug 184 as well as the base 181 fit into the shell of the fish body, so as to cause a watertight seal of the charging port area of the lure.

As detailed above the lure 1000 of the present invention may utilise remote control technology. Furthermore, in some embodiments if the fish body was internally provided with sensors capable of sensing acoustic-optic variation or touch and a microprocessor capable of processing the sensing signals, autonomous control can be realized.

The lure 1000 may benefit from autonomous or remote control in order to present itself better to target fish to be caught.

Remote contact with a ‘fish finder’ located on a boat or vessel, so the lure 1000 is controlled to swim towards a school of fish is also envisaged.

The biomimetic lure 1000 of the present invention can realistically simulate forward movement, turning and up-down traverse. It can be operated flexibly and conveniently and may be controlled by various drive circuit programs and/or by remote control.

Also, as the lure 1000 has its own drive mechanism, the lure 1000 does not need to be constantly jigged or popped, nor does it need flowing water around it to produce a real live bait fish movement. This saves effort for the fisherman as they can have multiple lines in the water that don't need constant attention to jig them.

It is an advantage for the present invention to have simple structure and well-designed dynamic system. The biomimetic lure 1000 can be flexibly driven and its center of gravity can be adjusted by interacting variable magnetic fields in the coil with fixed magnetic field of a magnet. The magnetic or electric fields themselves may also attract target fish.

Furthermore, fish pheromones or oils or other attractive substances to the target fish can be impregnated into the lure 1000, or stored within the lure 1000 and ejected such as at desired or period times.

The biomimetic lure 1000 of the present invention realistically simulates motions of bait fish in nature; a user can conveniently conduct the functions, such as moving forward, turning left and right, diving and floating and the like, by means of several control ways. The present invention has high flexibility and strong reliability and is capable of supporting remote control and self-programming control.

As described by the embodiment of the invention, methods for driving and controlling other biomimetic lure 1000 having the same or similar structure of the invention are seen to fall within the scope of the invention.

Furthermore, the lure 1000 may not come supplied with a hook 1000 as like other conventional lures. The lure 1000 providing means to attach a line or hook or tracer or jig to it. The lure 1000 may come supplied in a kit, containing the lure 1000, an assortment of hooks, clips, swivels etc. Or the lure may come as a standalone product, to be added to a fisherman's assortment of jigs.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

I claim:

1. An active fishing lure comprising or including:
a body able to simulate some appearance and at least some movement of a bait species, the body being adapted for line attachment (directly or indirectly) and mounting or being attached to or being adapted to attach to at least one hook,
an energy storage device carried by or forming part of the body or its content,
a drive connected to the energy storage device able to cause said at least some movement of the body, and
an initiator able to initiate the drive and thus the active movement of the body whilst drawing energy to the drive from the energy storage device.

2. A lure as claimed in claim 1 wherein the initiator is selected to initiate the drive in manner being one of:
manual initiation
water immersion initiation.

3. A lure as claimed in claim 1 wherein the drive is water immersion maintained

4. A lure as claimed in claim 1 wherein the drive is timer deactivated.

5. A lure as claimed in claim 1 wherein the drive is timer activated.

6. A lure as claimed in claim 1 wherein the lure can be configured and adapted to have negative buoyancy, neutral buoyancy or a positive buoyancy device.

7. A lure as claimed in claim 1 wherein the body simulates the head and tail of a bait species fish and the active movement is a swishing of such tail.

8. A lure as claimed in claim 1 wherein the lure can be adjustable in respect of its centre of gravity relative to its centre of buoyancy.

9. A lure as claimed in claim 1 wherein the hook is presented from said body.

10. A lure as claimed in claim 9 wherein the hook is rigidly secured or integrally formed with the body.

11. A lure as claimed in claim 1 wherein the hook is adapted to attach to said line.

12. A lure as claimed in claim 1 wherein the body is adapted to attach to said line.

13. A lure as claimed in claim 1 wherein said body is able to transmit into water a fish attractant comprising at least one of:
a. light
b. sound
c. vibration
d. scent such as pheromones.

14. A lure as claimed in claim 1 wherein said drive is remotely controllable.

15. A lure as claimed in claim 14 wherein said drive is controlled by input from a remote source.

16. A lure as claimed in claim 15 wherein the remote source is coupled to a fish finder capable of sensing fish in proximity of the lure and cause the drive to make the lure become more sensed by said fish when in proximity of the lure.

17. A fishing lure of a kind attached to or adapted to attach to a fishing line or trace or snood thereof (whether through a swivel or like device or not) and of a kind mounting, attached to or adapted to attach to at least one hook (whether through a swivel or like device or not), the lure being characterised in that it has a movement capability able to be initiated by one selected from manually and by water immersion and reliant on an energy storage device of the lure.

18. A lure as claimed in claim 17 wherein the movement capability is a swishing articulation of the body simulating the movement that propels a bait species through a body of water.

19. An active fishing lure comprising a body carrying an energy source and requiring water immersion to cause a draw of power from its energy storage device to a movement drive that causes some activity of the lure in the water.

20. A lure as claimed in claim 19 wherein the activity is a motion of the body.

21. A lure as claimed in claim 20 wherein the body is articulated and the motion is an oscillatory articulation of the body.

22. A lure as claimed in claim 19 where the activity is to simulate the swimming movement of a fish bait species.

23. A lure as claimed in claim 17 wherein the drive can be initiated other than by water immersion.

24. A lure as claimed in claim 17 wherein the drive may be terminated by a timer.

25. A fishing lure able to self articulate provided it being maintained in the water being fished, such articulation being independent of any water movement over the lure.

26. A lure as claimed in claim 25 wherein said articulation is caused by an electrically powered drive of said lure.

27. A fishing lure able to be activated and/or reactivated and/or be maintained active under any one or more of the following modes to articulate, wriggle, swish or the like to simulate the movement of an appropriate bait creature (real or otherwise), said movement to be of part or some of the lure relative to some other part or portion responsive to a drive rendered active from an energy storage device; said modes being at least some of
manual activation
liquid immersion activation or reactivation
timer ceased deactivation followed by liquid immersion reactivation.
